(19) United States
(12) Patent Application Publication
(10) Pub. No.: US 2003/0019697 A1
(43) Pub. Date: Jan. 30, 2003

(54) Spring applied electronic release parking brake

(76) Inventors: Michael Heaton, Rock Hill, SC (US); William P. Buckner, Grosse Ile, MI (US)

Correspondence Address: CARLSON, GASKEY & OLDS, P.C., 400 WEST MAPLE ROAD, SUITE 350, BIRMINGHAM, MI, 48009, US

(21) Appl. No.: 09/915,805

(22) Filed: Jul. 26, 2001

(51) Int. Cl. B60L 7/00

(52) U.S. Cl. 188/158

(57) ABSTRACT

A vehicle parking brake assembly is particularly useful as a driveline parking brake. The parking brake assembly is spring applied and electrically released. A mechanical spring operates to move an engaging portion into a braking position when the parking brake is applied. An electrically powered actuator operates to selectively move the spring against the bias of the spring to thereby release the parking brake.

### BACKGROUND OF THE INVENTION

This invention generally relates to vehicle parking brakes. More particularly, this invention relates to a spring applied, electronic release parking brake.

Vehicle braking systems are well known. Most vehicles include brakes that are selectively applied by a vehicle operator to slow down or stop a vehicle as needed. Additionally, most vehicles include a parking brake that is useful for preventing unexpected or undesirable movement of the vehicle when it is at rest.

Parking brakes take a variety of forms. In one heavy vehicle example, the brakes used for slowing down the wheels of the vehicle also function as a parking brake. In one configuration, a dual chamber brake actuator includes two chambers that are pressurized by air or hydraulic fluid. A first one of the compartments is used to control the brake under normal operating conditions. A second one of the compartments operates to set a parking brake. Additionally, such arrangements operate as an emergency brake when pressure is lost in the supply lines of the brake system.

Such braking arrangements are often referred to as spring applied hydraulic release or spring applied air release brakes. These names indicate that a spring is used to apply the braking force while the hydraulic or air pressure is utilized to release the braking force as needed.

Other types of parking brakes include driveline parking brakes. These arrangements typically include a braking assembly that acts directly upon one or more of the components in the vehicle driveline rather than operating in conjunction with or as part of the brakes used to slow down the wheels of the vehicle. Driveline parking brakes typically use lever and cable arrangements where a vehicle operator manually pulls a lever to set the driveline parking brake. When set, the driveline parking brake prevents the driveline components from moving so that the vehicle cannot be driven. Releasing the brake in such arrangements is typically done manually by the operator of the vehicle moving the lever in a direction opposite from that used to set the parking brake.

More recently, it has been proposed to incorporate spring applied hydraulic release or spring applied air release arrangements for setting and releasing the mechanical driveline parking brake. While such arrangements provide some advantages to older systems, those skilled in the art are always striving to make improvements. This invention provides a novel parking brake assembly that provides possible cost savings and additional operator convenience and simplified maintenance compared to other arrangements.

### SUMMARY OF THE INVENTION

In general terms, this invention is a parking brake assembly that relies upon a spring force to place the parking brake into a braking condition and includes an electrically powered actuator for releasing the brake.

A parking brake assembly designed according to this invention includes an engaging portion that is moveable into a braking position. A spring biases the engaging portion into the braking position. An electrically powered actuator moves the spring against the bias of the spring to thereby release the engaging portion from the braking position.

In one example, the engaging portion includes a duplex cam, mechanically activated braking arrangement. The engaging portion is supported at a selected point between an output of the vehicle transmission and a drive axle to provide the appropriate braking force as needed.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically illustrates selected portions of an example embodiment of this invention.

FIG. 2 schematically illustrates selected portions of another example embodiment of this invention.

FIG. 3 schematically illustrates selected portions of a brake assembly designed according to this invention.

### DETAILED DESCRIPTION OF THE PREFERRED EMBODIMENTS

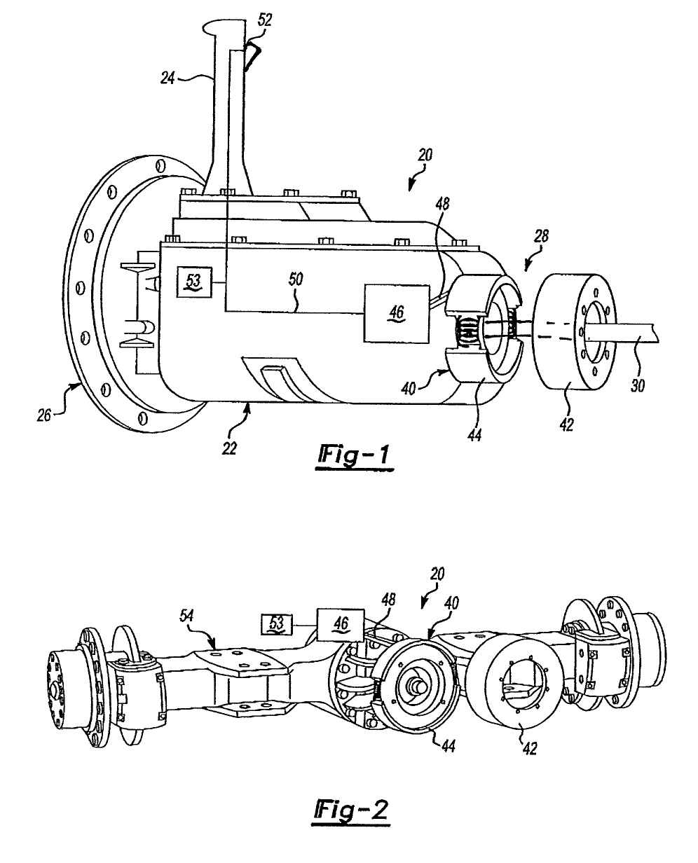

A vehicle driveline assembly 20 is partially shown in FIG. 1. The transmission gearbox housing 22 houses a plurality of gears that are selectively engaged by moving a shift lever 24 in a conventional manner. The transmission housing 22 has an input side 26, which receives an input force from a vehicle engine. An output side 28 of the transmission includes an output shaft 30 that provides a driving force to wheels on the vehicle in a conventional manner.

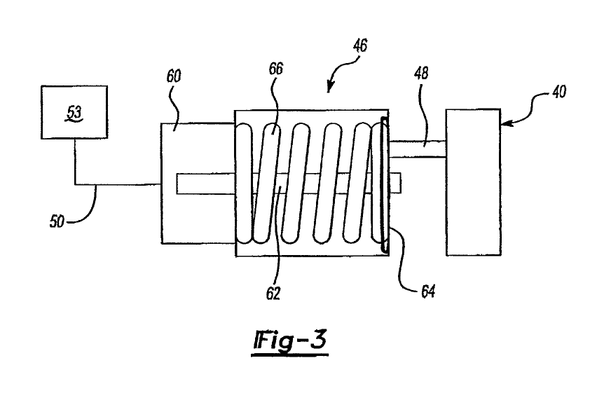

A parking brake assembly 40 includes a housing portion 42 that preferably is fixed to the drive shaft 30 so that the housing portion 42 rotates with the drive shaft 30. An engaging portion 44 is supported to selectively engage the housing 42 to provide a braking force in a braking position. The illustrated example includes a duplex cam mechanical arrangement where brake pads move in a generally outward direction to engage an inner surface on the housing 42 to provide a braking force. An actuator portion 46 includes a mechanical spring (see FIG. 3) that moves a lever 48 to cause the engaging portion 44 to move into the braking position. The actuator portion 46 preferably also includes an electrically powered actuator that operates to release the engaging portion 44 from the braking position.

The example of FIG. 1 includes an electrical coupling 50 between a switch 52 and the actuator portion 46. The switch 52 allows the vehicle operator to selectively set or release the parking brake as desired. A controller 53, which may be a suitably programmed on-board microprocessor, preferably controls operation of the brake 40. The controller 53 preferably is responsive to activation of the switch 52 to regulate the supply of electrical power to the actuator.

FIG. 2 illustrates an alternative embodiment where the parking brake assembly 40 is supported relative to an axle assembly 54 rather than at a location adjacent to the transmission gearbox housing 22. Otherwise, the example of FIG. 2 operates the same as that of FIG. 1.

With reference to FIG. 3, an example actuator portion 46 includes an electrically powered actuator 60. Example electrically powered actuators include electric motors such as DC motors, AC motors, servo motors or other electrically powered linear actuators.

The illustrated example include an arm 62 that is moved by electrically powered actuator 60. A support member 64 preferably is supported near one end of the arm 62. As the electrically powered actuator 60 moves the arm 62 (to the left according to the illustration), the support member 64 preferably compresses the spring 66 against the bias of the spring. In one example, the arm 62 is threaded so that rotary motion caused by the electrically powered actuator 60 draws the arm 62 in a direction that moves the spring 66 against the bias of the spring. Such motion releases the parking brake assembly 40 from the braking position.

In this example, whenever power is supplied to the actuator 60, the parking brake is released. If power is turned off to the electrically powered actuator 60 there is no force against the bias of the spring 66 so that the spring 66 moves into a position to cause the lever 48 to urge the engaging portion 44 into the braking position. The controller 53 preferably is programmed to regulate the supply of power to the actuator 60. In one example, the controller is programmed to automatically cut off power to the actuator whenever the transmission is in a selected state. In one example the controller 53 determines when the vehicle engine is off and the transmission is in neutral and automatically sets the parking brake.

Given this description, those skilled in the art will be able to choose from among commercially available electrically powered actuators to achieve the results provided by this invention. The actuator must be capable of withholding the spring 66 against the bias of the spring, which typically involves forces on the order of 1,000 pounds.

The preceding description is exemplary rather than limiting in nature. Variations and modifications to the disclosed embodiments of a spring applied, electrically released parking brake assembly may become apparent to those skilled in the art that do not necessarily depart from the essence of this invention. For example, it is possible to eliminate a controller and to have a direct switch-to-actuator power coupling. The scope of legal protection given to this invention can only be determined by studying the following claims.

We claim:

1. A parking brake assembly, comprising:
an engaging portion that is moveable into a braking position;
a spring that biases the engaging portion into the braking position; and
an electrically powered actuator that moves the spring against the bias of the spring to thereby release the engaging portion from the braking position.

2. The assembly of claim 1, wherein the actuator comprises an electric motor.

3. The assembly of claim 2, wherein the actuator comprises a servo motor.

4. The assembly of claim 2, wherein the actuator comprises a linear actuator.

5. The assembly of claim 1, including an arm associated with the actuator and a support near one end of the arm, the support engaging a portion of the spring such that movement of the arm causes movement of the spring against the bias of the spring.

6. The assembly of claim 4, wherein the arm rotates about an axis of the arm and the rotation of the arm causes linear movement of the support.

7. The assembly of claim 1, wherein the actuator moves into a disengage position where the engaging portion is released from the braking position when the actuator is energized at a first level and the actuator releases the spring to bias the engaging portion into the braking position when the actuator is energized at a second level.

8. The assembly of claim 7, wherein the second level includes the actuator being de-energized.

9. The assembly of claim 1, including a control switch that is actuatable by an operator of the vehicle and wherein the control switch controls the supply of electrical power to the actuator.

10. The assembly of claim 1, including an electronic controller that regulates power supplied to the actuator.

11. The assembly of claim 10, wherein the controller automatically cuts off power to the actuator under selected conditions.

12. A method of controlling a vehicle parking brake that is spring activated, comprising the steps of:
(A) permitting the spring to bias the parking brake into a braking condition; and
(B) selectively releasing the parking brake by electrically powering an electrical actuator that causes movement of the spring against the bias of the spring.

13. The method of claim 12, wherein step (B) includes energizing the actuator to thereby release the parking brake.

14. The method of claim 12, wherein step (A) includes de-energizing the actuator.
